(19) United States
(12) Patent Application Publication
(10) Pub. No.: US 2013/0211956 A1
(43) Pub. Date: Aug. 15, 2013

(54) Mobile Application for Capturing Inspirations

(71) Applicant: Bamboo Rose LLC, (US)

(72) Inventors: Susan Welch, Gloucester, MA (US); Kamal Anand, Danvers, MA (US)

(73) Assignee: Bamboo Rose LLC, Gloucester, MA (US)

(21) Appl. No.: 13/740,656

(22) Filed: Jan. 14, 2013

Related U.S. Application Data
(60) Provisional application No. 61/586,564, filed on Jan. 13, 2012.

(51) Int. Cl. G06Q 30/06

(52) U.S. Cl. CPC G06Q 30/0623
USPC 705/26.8; 705/26.61

(57) ABSTRACT

A system, method, and mobile application for capturing and synchronizing information is disclosed. One method can comprise capturing information relating to an object, generating an entry based upon the captured information, and automatically transmitting the entry to an online marketplace.

### CLAIM OF PRIORITY

This application claims priority from U.S. Provisional Patent Application. No. 61/586,564 filed on Jan. 13, 2012, which is relied upon and incorporated herein in its entirety by reference.

### BACKGROUND

Retailers, buyers, and/or merchants often travel to different countries, markets, suppliers, showrooms and/or tradeshows to shop for new products. During these trips, shoppers can become inspired by what they see and may identify products or ideas for products they would like to sell to their customer(s) or to be the basis for development of their own private label products.

Currently, shoppers can capture the information on these shopping trips using handwritten notes or entering information on their computers using document creation software or spreadsheets. Shoppers may also capture images, videos, and/or audio using electronic devices like camera, camcorders, cell phones etc. In addition, during their shopping trips, shoppers can collect physical samples of goods or may request that a sample be sent to them. On their return from shopping trips, shoppers typically enter such information into company software systems to further define product requirements, to follow up with suppliers on sample status or for additional information, or to organize for dissemination out to multiple suppliers for quotes or counter offers. During this time the shoppers will interact with the suppliers over the phone, email or other such means. This manual and ad-hoc process is time consuming and typically takes the buyer 30 to 45 days.

Current methods of data collection are prone to error caused by buyer input issues. In addition, the buyer must constantly follow up with suppliers via email, phone, and fax and with the various carriers to track sample delivery information. A buyer is left with minimal time to seek internal feedback that is quantified and valuable. When a buyer wants to proceed to the buying functions which are supported by internal technology, all of the information must be inputted into the appropriate system, which can be a time consuming, error prone task that further delays the ability to get to market faster.

### SUMMARY

The present disclosure relates generally to a mobile application capturing inspirational images and information to be used as a basis for creating designs and products, shopping for new products or applications, visiting tradeshows for products, inspirations, and ideas, and/or developing wish lists of items for purchase/sale/resale. In an aspect, the present disclosure relates to the capture of images, product and supplier information related to themes, tradeshows, suppliers, and products for use later in a product development and sourcing processes, for example.

In an aspect, the present disclosure relates to the capture and uploading of the inspirational images and information, which include products and information obtained at tradeshows, to an online market place. The captured inspirational images and information can include text attributes such as name, description, prices, sellers and multimedia such as images, audio and video. As an example, inspirations can be captured by entering a title, associating a picture, taking a picture, and/or capturing a video or audio clip. In an aspect, all captured items can be uploaded to the online market place. The inspiration capturing mobile application allows the buyer to enter tradeshow name, location, dates, booths/showrooms visited and items/products data. The items/products data includes name, description, notes, images, videos and/or audio clips. The inspiration capturing mobile application is configured to automatically synchronize with the online market place. As an example, the inspiration capturing mobile application can be used to capture aspects of the present disclosure and can be embodied as software running on a smart phone, tablet or any other hand-held wireless device. Along the same lines, the inspiration mobile application is configured to interact with the buyer through the user interface means provided by the hand-held wireless devices.

In an aspect, the inspiration capturing mobile application can comprise a software application that retail buyers and designers can use to capture items (product or inspiration) information while traveling or shopping at tradeshows and vendor showrooms. As an example, an item can be associated with a name, a brief description, additional attributes or multimedia such as images, video and audio. As a further example, when a buyer is at a tradeshow, the buyer can visit individual exhibitor booths or vendor showrooms, take notes, browse products and make seller connections. In an aspect, the inspiration capturing mobile application can enable the buyer to easily capture all product and supplier information during the tradeshow shopping experience. Further, the inspiration capturing mobile application mobile application can seamlessly connect with an online market place to upload the items and tradeshow information. The online market place can provide a platform for the buyers to review and manage the supplier, product or inspirations information collected or input. The buyers can connect back with the suppliers, invite them to join the marketplace, request samples, collaborate on further development of products, or build wish lists to broadcast internally to their own designers or externally to other suppliers etc.

In an aspect, inspiration capturing mobile application can be configured to help designers by capturing images and key attributes of what is inspiring them and to share that information with internal teams or external suppliers to begin the process of designing goods for inclusion in their retail assortments.

The faster a buyer can get this information disseminated and out to his community of peers and suppliers, the better positioned he is to capitalizing on his shopping trip by making commitments to suppliers and getting trend right merchandise into the stores as quickly as possible. The ability to cut out up to 45 days in a buying cycle results in the buyer being able to spend more time collaborating on product design which means he can make decisions closer to consumer demand. That translates into additional sales and fewer markdowns as he cuts down the time to market. Accordingly, the present disclosure provides means to shorten the buying cycle while synchronizing information from the field with online repositories and marketplaces.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is a representation of an exemplary method of capturing and uploading information by a buyer;

FIG. 2 is a representation of an exemplary method of capturing information with a mobile application;

FIG. 3 is a representation of an exemplary mobile application;

FIG. 4 is a representation of an exemplary mobile application;

FIG. 5 is a representation of an exemplary method of capturing information with a mobile application;

FIG. 6 is a representation of an exemplary mobile application;

FIG. 7 is a representation of an exemplary mobile application;

FIG. 8 is a representation of an exemplary mobile application;

FIG. 9 is a representation of an exemplary mobile application;

FIG. 10 is a representation of a schematic of uploading information from a mobile device to an online marketplace;

FIG. 11 is a representation of the method shown in FIG. 10;

FIG. 12 is a representation of an exemplary wish list entry;

FIG. 13 is a representation of an exemplary method of creating a wish list entry;

FIG. 14 is a representation of an exemplary interface of an online marketplace;

FIG. 15 is a representation of another exemplary interface of an online marketplace; and

FIG. 16 is a representation of an exemplary computing device.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, smart phone, tablet, hand-held wireless device, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

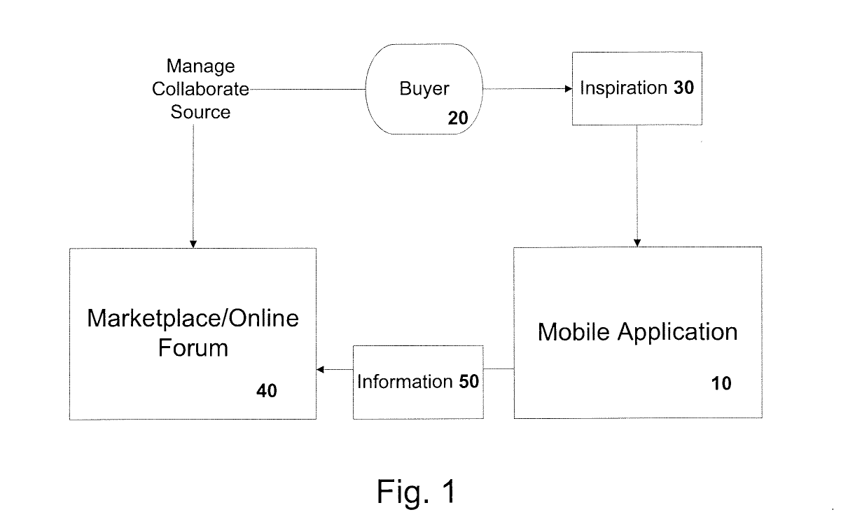

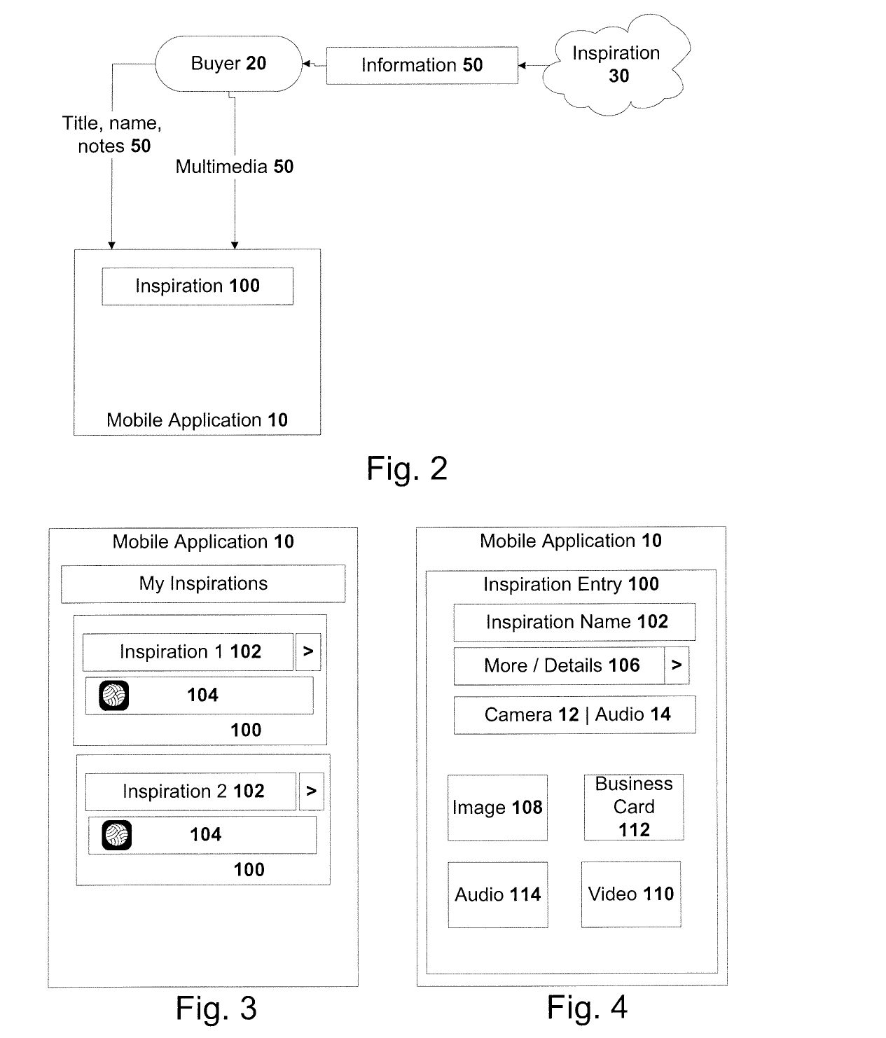

In an aspect, FIGS. 1 and 2 illustrate an inspiration capturing mobile application 10 that allows a buyer 20 to shop and seamlessly upload information 50 captured from objects 30, such as inspirations and items, to an online marketplace 40. After the information 50 has been uploaded, the buyer 20 can log into the online marketplace 40 to manage any information 50 stored thereon, as discussed below.

In an aspect, as illustrated in FIG. 2, the buyer 20 of the inspiration capturing mobile application 10 can use the application to capture inspirations 30. An inspiration 30 can be any information that is related to or concerns an object, including, but not limited to, a product in a shopping window, an idea or concept that can be found anywhere the buyer 20 ventures. As an example, the buyer 20 can create an inspiration entry 100 within the mobile application 10 by capturing information 50 relating to the inspiration 30. For example, the mobile application 10 can capture the inspiration entry by entering a name or title, notes (i.e., information 50), and/or selecting the link for a camera to take a picture (information 50) of the object/inspiration 30. As a further example, the buyer 20 can also choose to record video 50 or audio 50 of the inspiration 30. The buyer 20 can take any number of pictures 50 and associate those pictures 50 with any inspiration 30. Additionally, the buyer 20 can also take picture of a business card to avoid typing in the information 50. Using this process, the buyer 20 can create any number of inspiration entries 100.

In an aspect, FIG. 3 illustrates the mobile application 10 listing the inspiration entries 100 captured by a buyer 20. For each inspiration entry 100 an inspiration name 102 can be displayed. The inspiration name 102 can be any form of a unique identifier that can be associated with the inspiration 30. In addition to the inspiration name 102, the mobile application 10 can display a first image 104 of any pictures associated with the inspiration 30 captured with the inspiration entry 100. While FIG. 3 only shows two inspiration entries 100, the mobile application 10 is configured to display multiple inspiration entries 100, dependent on the number of inspiration entries 100 captured by the buyer 20. The display options can be set by the buyer 20.

The mobile application 10 at the initiation of the buyer 20 (on-demand) or automatically (as scheduled), can upload the captured inspiration entries 100 to an online marketplace 40, as shown in FIGS. 1 and 10-11, discussed in more detail below.

In an aspect, FIG. 4 illustrates a screen display for the mobile application 10 representing an inspiration entry 100. The display of the mobile application 10 shows the information 50 captured for each inspiration 30. As a further example, each inspiration entry 100 for each inspiration 30 can have an inspiration name 102 and other fields for other information 50, including details 106. Details 106 can include, but are not limited to, price range, comments, and the classification of the inspiration 30. For example, the inspiration entry 100 can capture the type of inspiration, including, but not limited to, toys, apparel, furniture, and other consumer goods, materials, and art.

In an aspect, for the inspiration 30, the buyer 20 can capture different forms of information 50 in the inspiration entry 100. For example, the mobile application 10 can call on the associated mobile device to activate a camera 12 associated with the mobile device to take pictures/images 108 or videos 110 of the inspiration 30. The mobile application 10 can provide a link directly to the camera 12 of the mobile device to capture the picture 108 or video 110, or import pictures 108 and images 110 captured by and stored on the mobile device when the mobile application 10 is not in use. One of the images 108 captured and imported into the inspiration entry 100 can then be assigned or selected to be the image 104 that is viewable in a list form of the inspiration entries 100, as shown in FIG. 3. In addition, the camera 12 can be called on to capture images of business cards 112. The business card images 112 are separately identified to enable the marketplace 40 to scan them into text after upload. For example, the business card pictures 112 can include a marker or identifier, such as key word “card” in the image name, to alert the online marketplace 40 after upload, discussed in further detail below.

The buyer 20 can also create audio entries 114 for the inspiration entry 100 as well. Similar to the images 108 and video 110, the mobile application 10 can provide a link directly to the audio recorder 14 of the mobile device to capture the audio entry 114, or import a stored audio entry 114 on the mobile device. In an aspect, the captured multimedia 108, 110, 112, 114 can be displayed on the inspiration screen for each inspiration entry 100. In some embodiments of the present invention, the mobile application 10 is configured to call on the mobile device to playback selected captured media by selecting through means available with the mobile device the desired media file (picture 108, video 110, audio 114) to review.

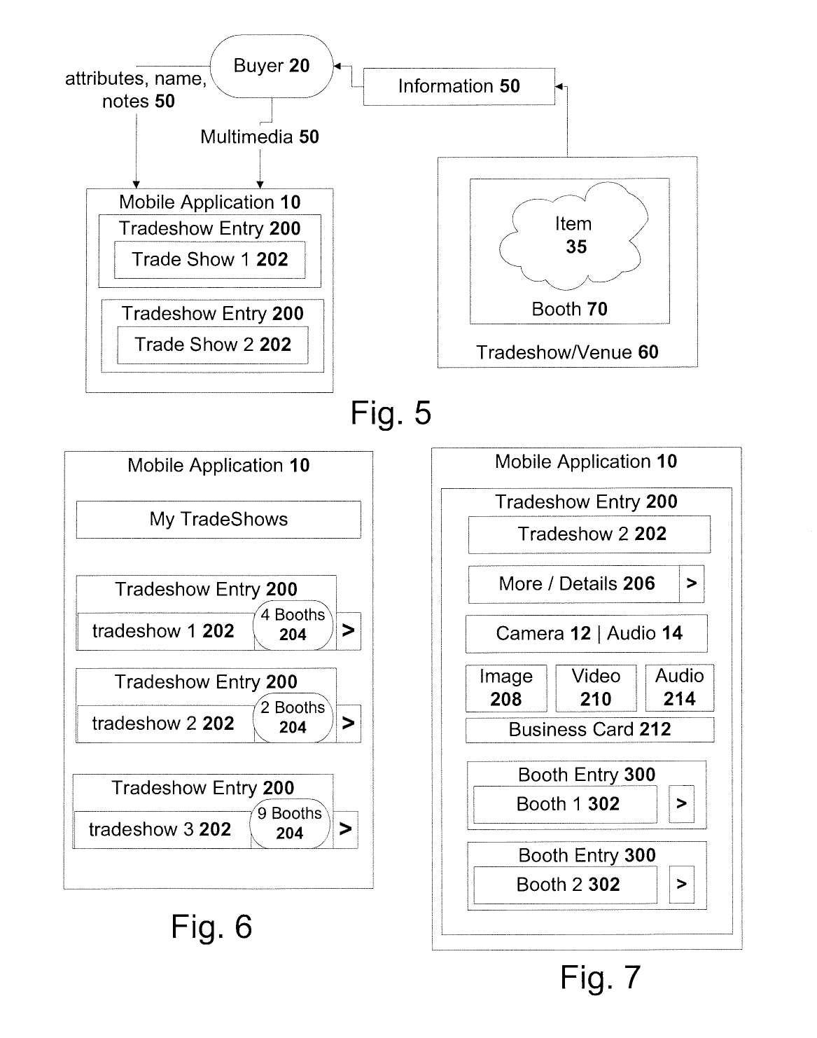

In an aspect, FIG. 5 illustrates the process of a buyer 20 using the mobile application 10 to capture information 50 relating to items 35 at a tradeshow 60. Similar to an inspiration 30, an item 35 can be any information that is related to or concerns an object, including, but not limited to, a product, a concept or an idea, but can be associated with a tradeshow 60 and/or a booth 70. The buyer 20 can capture information 50 related to the tradeshow/venue 60, booths 70 at the tradeshow 60, and items 30 found within the booths 70. This information 50 may be included in a tradeshow entry 200. As an example, as the buyer 20 is visiting a tradeshow 60, the buyer 20 can enter information 50 about the tradeshow such as the different booths 70 visited and the items 35 seen in the booths. The buyer 20 can store the tradeshow information 50 within a tradeshow entry 200 utilizing the same features discussed above regarding the capture of information 50 for the inspiration entry 100. Further, the information 50 can be stored in a variety of types, including, but not limited to, electronic notes, attribute values, and multimedia pictures, audio and video. The buyer 20 can utilize the mobile application 10 to capture tradeshow information 50 in the tradeshow entries 200, including the tradeshow names 202 and other relevant information 50.

In an aspect, FIG. 6 illustrates a screen display showing the list of tradeshow entries 200 captured that correspond to the tradeshows 60 attended by the buyer 20. For each tradeshow entry 200, the mobile application 10 can keep track of the number 204 of booths 70 from which the buyer 20 created booth entries 300, discussed below.

In an aspect, FIG. 7 illustrates a schematic of a tradeshow entry 200 as displayed by the mobile application 10. The tradeshow entry 200 includes the tradeshow name 202, and other relevant details 206. The tradeshow name 202 can be any form of a unique identifier that can be associated with the tradeshow 60. The details 206 can include important information 50 related to the tradeshow, including but not limited to, date(s) for the tradeshow 60 and any other attributes such as location, costs, and other facts, observations, or notes collected and/or formulated during the tradeshow 60. In addition to the details 206, and similar to the inspiration entry 100, information 50 from the tradeshow 60 can be captured in the form of multimedia. For example, the mobile application 10 can call on the associated mobile device to use the camera 12 or audio recorder 14 to capture pictures 208, videos 210, business cards 212, and audio 214 related to the tradeshow 60.

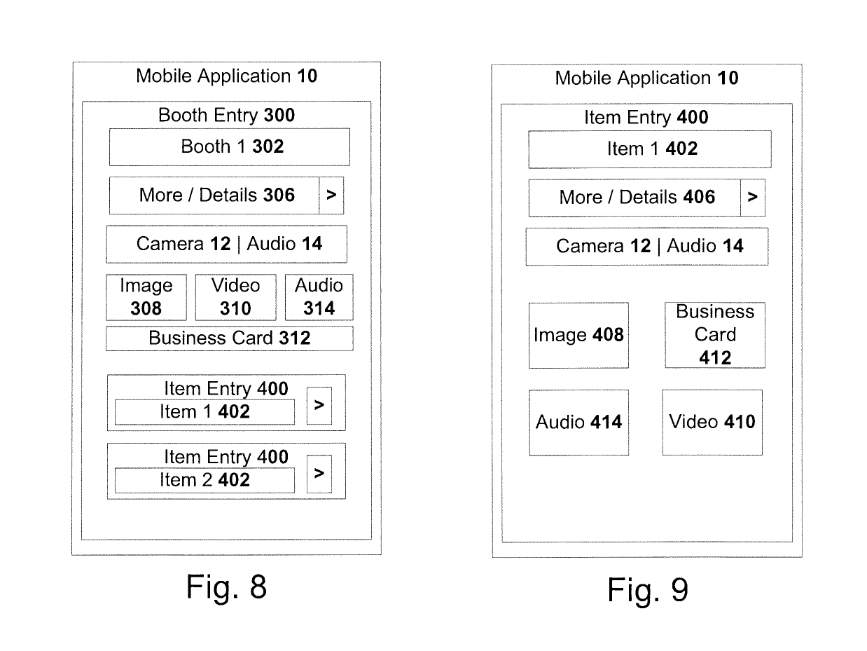

As shown in FIG. 7, and shown in more detail in FIG. 8, the tradeshow entry 200 can include booth entries 300 captured at the tradeshow 60 by the buyer 20 through the mobile application 10 for booths 70 that are associated with the particular tradeshow 60. The booth entries 300 can be identified by a booth name 302 within the tradeshow entry 200. The booth name 302 can be any form of a unique identifier that can be associated with the booth 70.

FIG. 8 illustrates a representation of a booth entry 300. The buyer 20, through the mobile application 10, can create booth entries 300 that correspond to selected booths 70 observed at the tradeshow 60. Similar to the inspiration entries 100 and tradeshow entries 200, booth entries 300 include booth names 302 identifying the booths 70. Additional information 50 relating to the booth 70, including, but are not limited to, vendor/supplier/exhibitors names and related classifications, contact information, item types being sold, price ranges, comments, and other related attributes can be captured as details 306.

For each booth entry 300, a buyer 20 can utilize the mobile application 10 to call on the associated mobile device to activate the camera 12 and/or audio recorder 14 associated with the mobile device to capture a picture 308, video 310, business card image 312, or an audio file 314 associated with the corresponding booth 70. As discussed above, the mobile application 10 can provide a link directly to the capturing devices 12, 14 or import the image 308/video 310/business card 312/audio file 314. The mobile application 10 can generate links to these multimedia files 308, 310, 312, 314 that can be displayed on the screen of the mobile device allowing immediate access for playback purposes.

In addition to capturing information for each booth 70, the mobile application 10 can be utilized to capture information 50 related to items 35 found at the booth 70 in the form of item entries 400. Further, the mobile application 10 can display the item entries 400 associated with each booth entry 300 for each item 35 associated with the corresponding booth 70, as shown in FIG. 8. The item entries 400 can be identified by an item name 402.

In an aspect, FIG. 9 illustrates a representation of a booth item entry 400. Similar to the inspiration entry 100, the booth item entry 400 corresponds to an item 35 that can be associated with a particular booth 70. The mobile application 10 is used to capture an item name 402 for the item entry 400. The item name 402 can be any form of a unique identifier that can be associated with the item 35. Other item details 406 can be captured as well, including, but not limited to, price, category, color/size, and other relevant information. For each item 35, the buyer 20 can take a picture 408, video 410, business card images 412 and/or audio recordings 414 in the same manner as described above for the inspiration entries 100, tradeshow entries 200, and booth entries 300. Likewise, the mobile application 10 is configured to generate links to the multimedia files 408, 410, 412 and 414 of the item entry 400 that can be displayed on the screen of the mobile device allowing immediate access for playback purposes.

In an aspect, as the buyer deploys 20 the mobile application 10 and wishes to capture images, video and/or audio notes while visiting the tradeshow floor, the information 50 can be synchronized with an online marketplace 40. The synchronized information can be accessed on the marketplace 40, thereby allowing the buyer 20 to review all the booths 70 visited as well as items 35 that he was interested in at each booth 70. The buyer 20 can organize inspirations 30 and items 35 by attributes, cull a shopping list further by deleting captured entries, adding additional notes and information, and/or creating wish list entries 500 from the shopping trip, discussed in detail below.

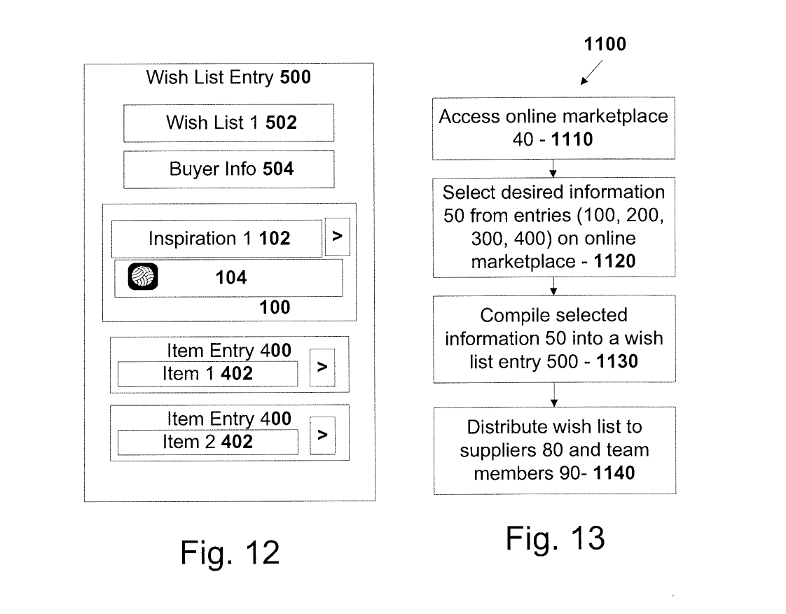

In an aspect, the mobile application 10 assists the buyer 20 in creating wish list entries 500, shown in FIG. 13 and described in more detail below, from the captured inspiration entries 100 and item entries 400. As an example, captured information 50, in the form of inspiration entries 100 and item entries 400 can be organized as a wish list entry 500 representing a grouping of favorite inspirations 30 and items 35 from various booths 70 at various tradeshows 60. The wish list entry 500 can also include concepts of a particular inspiration 30 or booth 70 as well (e.g., a product from one booth, a color scheme from another booth, an accessory from a third booth, a presentation from yet another—all automatically compiled based on input identifiers). The process of creating wish list entries 500 is discussed in more detail below and in reference to FIG. 12.

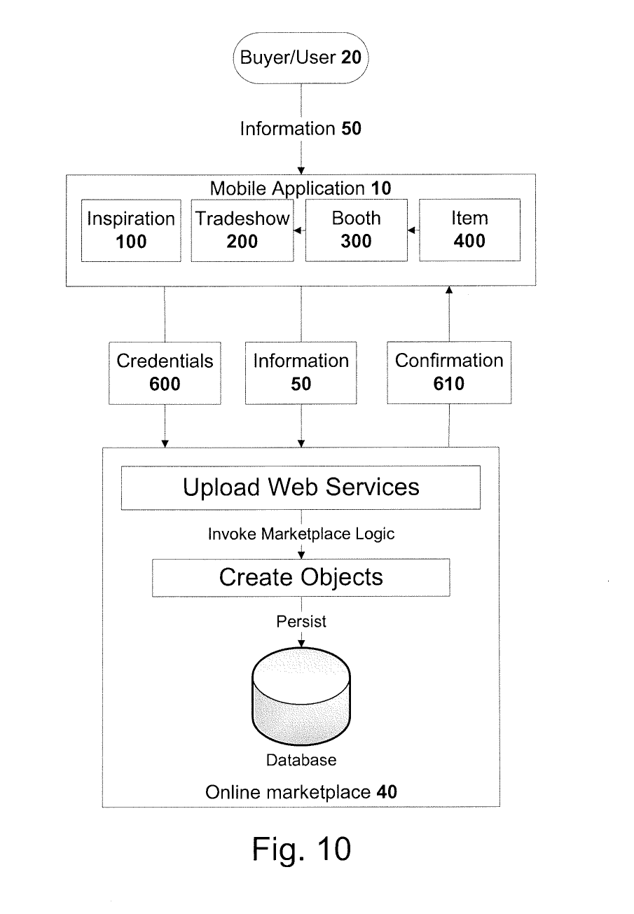

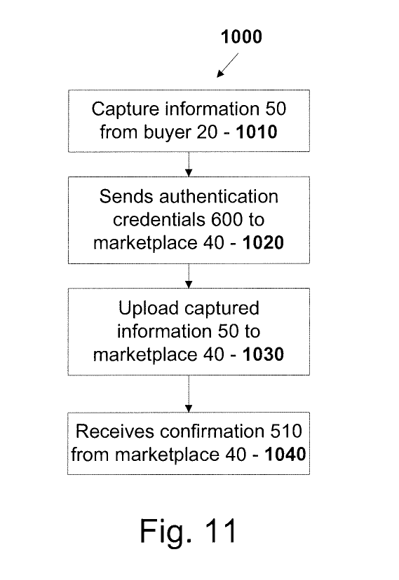

In an aspect, FIGS. 10-11 illustrate the upload process 1000 of information 50 captured by the mobile application 10 to an online marketplace or environment 40. In an aspect, the mobile application 10 can seamlessly upload (method 1000 of FIG. 11) the captured inspiration and tradeshow information 50, which is contained in the inspiration entries 100, tradeshow entries 200, booth entries 300, and item entries 400, to an online marketplace/online environment 40. An online marketplace 40 provides an environment for collaboration between buyers 20 and suppliers 80. In the marketplace 40, virtual showrooms can be created by buyers 20 and suppliers 80. The online marketplaces 40 can display products that buyers 20 currently sell, products that suppliers 80 can supply to buyers 20, and/or product types that are desired by buyers 20 from the suppliers 80. In online marketplaces, buyers 20 can upload the information 50 that they have captured related to their inspirations 30 and items 35, create wish list entries 500 and shop showrooms.

The mobile application 10 can connect to the marketplace 40 using the various communication means available to the mobile device (including, but not limited to, CMDA, GPRS, GSM, WiFi, Bluetooth, and the like) to provide access to the internet. To initiate the transfer process, the mobile application 10 must first have captured information 50 from the buyer 20 (step 1010), as discussed above. Once information 50 has been captured, which can be in the form of inspiration entries 100, tradeshow entries 200, booth entries 300, and item entries 400, the mobile application 10 can begin the transfer process by initiating a connection to the marketplace 30 based on the account credentials 600 of the buyer 20 (step 1020). Online marketplaces 40 typically require buyers to provide account credentials 600. The account credentials 600 can include an identifier and a password associated with the buyer 20 in order to gain access to the online marketplace 40. For example, the identifier for a buyer 20 can include an arbitrary selected name or a valid email address of the buyer 20. In the preferred embodiment, the mobile application 10 can use the identifier and password of the buyer (i.e., the account credentials 600) to access the online marketplace 40. In one embodiment of the present invention, the account credentials 600 are stored within the mobile device, and can be accessed by the mobile application 10 to authenticate the buyer 20 (step 1020). However, in other embodiments, the mobile application 10 can prompt the buyer 20 to supply the account credentials 600 to authenticate the buyer 20 to the online marketplace 40 (step 1020).

Once authenticated, the mobile application 10 can upload the captured information 50 in the form of inspiration entries 100, tradeshow entries 200, booth entries 300, and booth item entries 400 to the online marketplace 40 (step 1030). The uploading of the information 50 can be done automatically, on command from the buyer 20, or on-demand from the mobile application 10. In an aspect, the information 50 is uploaded using the APIs provided by the online marketplace 40. The data exchange can be performed using a number of different formatting languages, including, but not limited to, XML or JSON, as well as binary format for the multimedia files.

As discussed above, the inspiration entries 100, tradeshow entries 200, booth entries 300, and booth item entries 400 include all types of information 50 that has been captured in different ways. The mobile application 20 can capture the information 50 in the form of normal text files and multimedia files. The multimedia files include images, video clip files, audio files and pictures of business cards. The format of the uploaded multimedia files can be in the format natively supported by the mobile device or can be converted into a device neutral internet friendly format. Formats for the multimedia files include, but are not limited to, JPG and PNG for images and business card pictures; MOV or MP4 for video files; WAV and MP3 for audio files. The online marketplace 40 can then call on its servers to store and maintain the entries 100, 200, 300, and 400 according to a desired fashion. According to one embodiment, the entries 100, 200, 300, and 400 can be stored in databases found on storage devices of the servers of the online market 40.

After the mobile application 10 has completed the upload of the information 50 (step 1030), the mobile application 10 waits to receive a confirmation 610 from the online marketplace 40 to confirm that the information 50 has been successfully uploaded.

Once the information upload process (1000) has been completed, the buyer 20 can review and manage the uploaded entries 100, 200, 300, 400 from the online marketplace 40, which facilitates the information 50 being accessible to other buyers with access to the online marketplace 40. The upload process saves the buyer 20 from having to re-key this information 50 and speeds up their product development cycle. Additionally, the uploaded entries can be automatically shared with the team members of the buyer 20 as predefined by the buyer 20.

In an aspect, FIG. 12 illustrates a wish list entry 500. The wish list entry 500 can include a wish list name 502. The wish list name 502 can be any form of a unique identifier that can be associated with the wish list 500. The wish list entry 500 can also include buyer information 504 which can alert the supplier 80 or other team members 90 as to who to contact regarding the wish list entry 500 upon its distribution. While FIG. 12 only shows a combination of inspiration entries 100 and item entries 400, the wish list entry 500 can include a combination of inspiration entries 100, tradeshow entries 200, booth entries 300 and item entries 400 that the buyer 20 has captured via the mobile application 20 and uploaded to the online marketplace 40.

FIG. 13 illustrates an exemplary method (1100) for interacting with uploaded entries on the online marketplace 40 to create a wish list entry 500 for collaboration with other team members and suppliers 80. The buyer 20 must access the online marketplace 40 (step 1110), select the desired captured information 50 that is contained in the entries (step 1120), compile the selected information into a wish list entry 500 (step 1130). Once the wish list entry 500 is compiled, the buyer 20 can distribute the wish list entry 500 to the suppliers 80 or team members as desired (step 1140).

To access the online marketplace 40 (step 1110), the buyer 20 must supply to the online merchant place 40 the needed account credentials 600. The account credentials 600 should be the same credentials needed to upload the captured information 50 as discussed above.

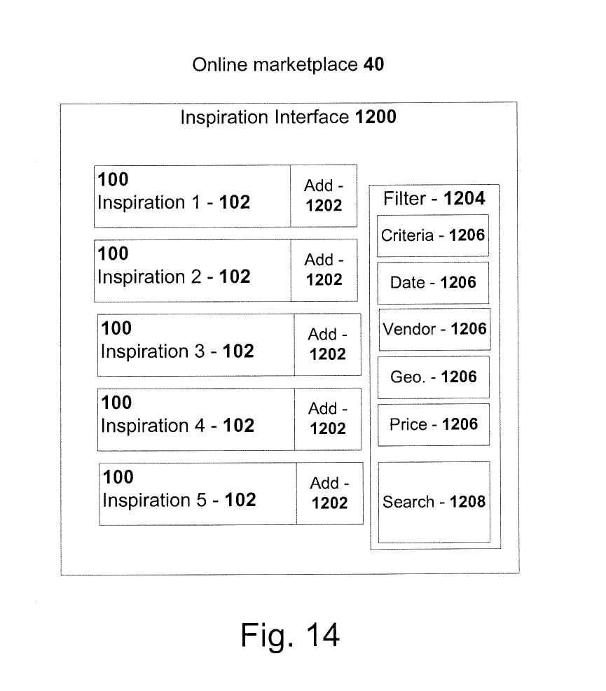

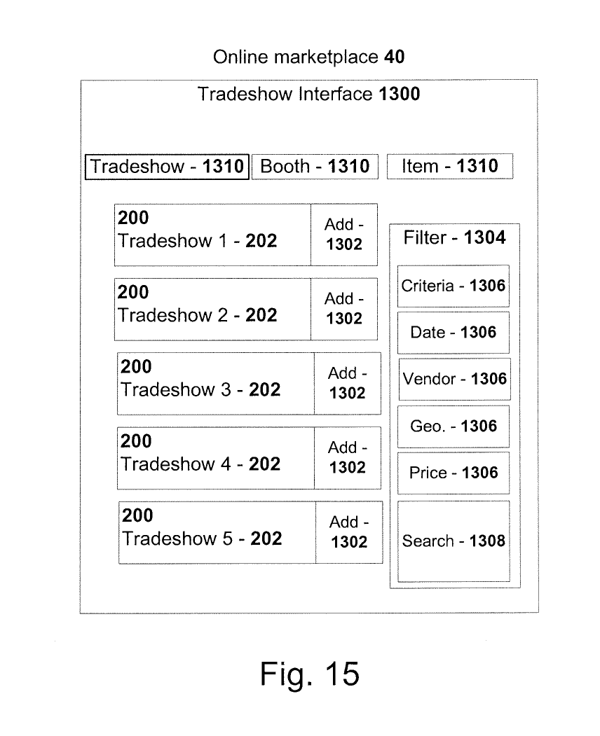

Once the buyer 20 has gained access to the online marketplace 40, the buyer 20 can use the services of the online marketplace 40 to search and filter the captured information 50 in order to find the desired information (step 1120). FIGS. 14-15 illustrate interfaces 1200, 1300 provided by the online marketplace 40 for the buyer 20 to utilize to select the desired information to create a wish list entry 500, as shown in FIG. 13.

As shown in FIG. 14, the inspiration search interface 1200 shows all of the inspiration entries 100 that have been uploaded by the buyer 20 and/or those to which the buyer 20 has been granted access by other team members 90. While FIG. 14 illustrates the inspiration entries 100 organized in a list view, embodiments of the present invention may use other organizational designs, including, but not limited to, grid views, to display the inspiration entries 100. Further, the inspiration search interface 1200 can be set to order the inspiration entries 100 in numerous ways, including, but not limited to, most recent inspiration entries 100 or alphabetical by inspiration name 102. Some sort of selection means 1202 will be provided that corresponds to each inspiration entry 100. As shown in FIG. 14, the inspiration search interface 1200 can provide adding tabs 1204 that allow the buyer 20 to select the inspiration entry 100 for addition to the wish list entry 500. However, in other embodiments of the present invention, other selection means 1202, including, but not limited to, radial buttons, check boxes, and the like, or interacting with the entry 100 itself may be used to add the inspiration entry 100.

The inspiration search interface 1200 also provides a filter 1204 that allows the buyer 20 to sort or filter the inspiration entries 100. Using the filter 1204, the buyer 20 can filter or sort the inspirations entries 100 based by type different types of filter criteria. For example, the buyer 20 can sort the inspiration entries 100 by selecting filter criteria 1206 that corresponds to information 50 contained in the details 106 of the inspiration entities 100. Such filter criteria 1206 can include, but is not limited to, date and time, geographical location, and vendor information, and the like. Further, the inspiration entries 100 can be sorted or filtered by entry name 102. The filter criteria 1206 can include the file types associated with the inspiration entry 100. For example, the inspiration entities can be sorted or filtered by whether or not the entry 100 includes an image 108, video 110, business card image 112, or an audio file 114. The filter 1200 can also provide a search function 1208 for specific information. The search function 1208 can employ various searching logic as known in the art (key word, Boolean, etc.). The search function 1208 can be used in conjunction with the filter criteria 1206 as well.

The inspiration filter 1200 can provide means for the buyer 20 to view the information 50 affiliated with the inspiration entry 100. For example, in one embodiment of the present invention, the inspiration filter 1200 can allow the buyer 20 to click on the inspiration entry 100, which can then display the information 50, including details 106 and files 108, 110, 112, and 114. The online marketplace 40 can call on various applications known in the art to display such information to the buyer 20.

Utilizing the filter function, the buyer 20 can select (step 1120) the inspiration entries 100 to be added to the wish list entry 500. In one embodiment of the present invention, the buyer 20 can add the desired inspiration entry 100 to the wish list entry 500 by activating the add tab 1202, which adds the inspiration entry 100 to the wish list (step 1130). According to one embodiment, the buyer 20 can choose and select parts of an inspiration entry 100 (e.g., parts of the details 106 and a few of the multimedia files)to the wish list entry 100, or the entire inspiration entry 100 can be added. The buyer 20 can repeat the searching and selecting steps (steps 1120 and 1130) until the wish list entry 500 is completed. Optionally, the buyer 20 can create a wish list entry 500 each time, or add to an existing wish list entry 500. Once the wish list entry 500 is created the buyer 20 can send the wish list entry 500 to suppliers 80 or share internally with other team buyers (step 1140).

Before distribution, the online marketplace 40 can automatically generate the wish list name 502 and buyer information 504, or can request the buyer 20 to provide such information. In some embodiments, the online marketplace can perform this action upon the initiation of the wish list entry process, or before distribution. The wish list entries 500 can be distributed by the online marketplace 40 through electronic means automatically or on-demand of the buyer 20 who created the wish list entry 500 The buyer 20 can choose to automatically share the uploaded inspiration entries 100 and item entries 400 with their internal teams, or distribute them on a selected basis.

A similar process can be followed to create a wish list entry 500 including the tradeshow entries 200 and the corresponding booth entries 300 and item entries 400. FIG. 15 illustrates a tradeshow interface 1300 according to one embodiment of the present invention. The tradeshow interface 1300 can display all of the tradeshow entries 200 available to the buyer on the online marketplace 40 in a similar fashion done by the inspiration interface 1200. The tradeshow interface 1300 includes selection means 1302 (e.g., adding tabs 1302) that when used or activated add the tradeshow entry 200 to the wish list entry 500. Other selection means 1302 can be utilized by other embodiments of the present invention.

Similar to the inspiration interface 1200, the tradeshow interface 1300 can include a filter 1304 where various filter criteria 1306 can be selected to find the desired tradeshow entry 200 to be added to the wish list entry 500. Such criteria 1306 can include the criteria 1206 utilized by the inspiration interface 1200, in addition to others. The filter 1300 can also provide a search function 1307 for specific information. The search function 1307 can employ various searching logic as known in the art (key word, Boolean, etc.). The search function 1308 can be used in combination with the filter criteria 1306 as well.

Given the relationships that occur between the tradeshow entries 200, the booth entries 300, and the item entries 400, the tradeshow interface 1300 includes toggle buttons 1310 that allow the buyer 20 to view and perform the sorting and filtering functions for each type. As shown in FIG. 15, the tradeshow toggle button 1310 has been selected, displaying and organizing information by tradeshow entries 200. However, the selection of other toggle buttons can display the booth entries 300 and item entries 400 instead, with the same capacity to add them to a wish list entry 500 as discussed above. The filter 1304, the filter criteria 1306, and the search function 1308 are as applicable to the booth entries 300 and item entries 400 as they are to the tradeshow entries 200.

Utilizing the filter function, the buyer 20 can select (step 1120) the tradeshow entries 200, booth entries 300 and item entries 400 to be added to the wish list entry 500. In one embodiment of the present invention, the buyer 20 can add the desired tradeshow entry 200 (or booth entry 300 or item entry 00) to the wish list entry 500 by activating the add tab 1302, which adds the tradeshow entry 100 to the wish list (step 1130). The buyer 20 can repeat the searching and selecting steps (steps 1120 and 1130) until the wish list entry 500 is completed. Once completed, the buyer 20 can then distribute the created wish list entry to other buyers 20 and suppliers 80 (step 1140).

In an aspect, the online marketplace 40 can facilitate the automatic sharing of uploaded entries between team members 90 of the buyer 20, allowing buyers 20 on the same team to create wish list entries 500 from collective information 50 of team members 90. The buyer 20 can define team members 90 in the online marketplace 40 with which the buyer 20 would like to share entries. The buyer 20 can create a team by giving it a name, then selecting other marketplace buyers to add to the team. The buyer 20 can then indicate if the collected entries should be automatically shared with team members 90 upon upload.

The buyer 20 can distribute information such as wish list entries 500 on the online marketplace 40 to team members 90 or to other suppliers 80 requesting that the suppliers 80 respond by creating offerings of inspirations 30 and/or items 35 that are the same or similar to what is represented in the wish list entry 500. By the time a buyer 20 returns from a shopping trip, all of the information/notes relating to the trip is assimilated and organized. A follow-up can be auto-generated with suppliers 80 of the booths 70 that were visited and suppliers 80 can be notified of requests for quotes or additional information. A buyer 20 can virtually share the information 50 captured during the shopping trip with others in an organization as well as externally with trading partners. Recipients of the captured information 50 can provide feedback on items such as “liked/disliked” as well as other commentary.

When the buyer decides to proceed to the buying functions of design, sourcing or ordering, the buyer 20 can call on the online marketplace 40 to upload the wish list entry 500 to an internal buying technology associated with the online marketplace 40. In an aspect, the buyer 20 can invoke a “Tell” button of the online marketplace 40, which will take the wish list entry 500, and all of the data, including, but not limited to, the images, video, audio, name, description and notes, and send to the internal buying technology in a pre-defined format. The internal buying technology can be any software application that a buyer 20 utilizes for buying merchandising. The internal buying technology can be a home grown system, an externally made system such as, but not limited to, TradeStone MLM software, or even ERP (e.g., Oracle, SAP). The medium of sending the wish list entries 500 can vary, ranging from utilizing a web service associated with a supplier 80, or creating corresponding text or spreadsheet files, along with the multimedia files, that can be posted to retailer FTP site.

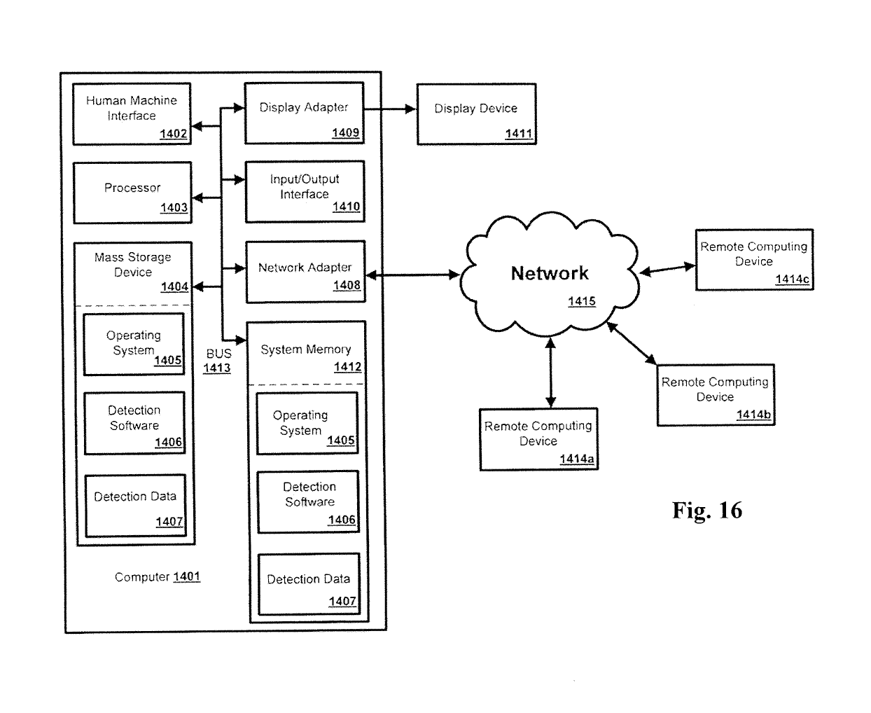

FIG. 16 is a block diagram illustrating an exemplary operating environment for performing the disclosed methods of the inspiration capturing mobile application 10. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 1401. The components of the computer 1401 can comprise, but are not limited to, one or more processors or processing units 1403, a system memory 1412, and a system bus 1413 that couples various system components including the processor 1403 to the system memory 1412. In the case of multiple processing units 1403, the system can utilize parallel computing.

The system bus 1413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1413, and all buses specified in this description can also be implemented over a wired or wireless network connection and each of the subsystems, including the processor 1403, a mass storage device 1404, an operating system 1405, synchronization software 1406, synchronization data 1407, a network adapter 1408, system memory 1412, an Input/Output Interface 1410, a display adapter 1409, a display device 1411, and a human machine interface 1402, can be contained within one or more remote computing devices 1414a,b,c at physically separate locations, connected through buses of this form, in effect implementing a fully distributed system.

The computer 1401 typically comprises a variety of computer readable media. Exemplary readable media can be any available media that is accessible by the computer 1401 and comprises, for example and not meant to be limiting, both volatile and non-volatile media, removable and non-removable media. The system memory 1412 comprises computer readable media in the form of volatile memory, such as random access memory (RAM), and/or non-volatile memory, such as read only memory (ROM). The system memory 1412 typically contains data such as synchronization data 1407 and/or program modules such as operating system 1405 and synchronization software 1406 that are immediately accessible to and/or are presently operated on by the processing unit 1403.

In another aspect, the computer 1401 can also comprise other removable/non-removable, volatile/non-volatile computer storage media. By way of example, FIG. 14 illustrates a mass storage device 1404 which can provide non-volatile storage of computer code, computer readable instructions, data structures, program modules, and other data for the computer 1401. For example and not meant to be limiting, a mass storage device 1404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1404, including by way of example, an operating system 1405 and synchronization software 1406. Each of the operating system 1405 and synchronization software 1406 (or some combination thereof) can comprise elements of the programming and the synchronization software 1406. Synchronization data 1407 can also be stored on the mass storage device 1404. Synchronization data 1407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the buyer can enter commands and information into the computer 1401 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 1403 via a human machine interface 1402 that is coupled to the system bus 1413, but can be connected by other interface and bus structures, such as a parallel port, game port, an IEEE 1394 Port (also known as a Firewire port), a serial port, or a universal serial bus (USB).

In yet another aspect, a display device 1411 can also be connected to the system bus 1413 via an interface, such as a display adapter 1409. It is contemplated that the computer 1401 can have more than one display adapter 1409 and the computer 1401 can have more than one display device 1411. For example, a display device can be a monitor, an LCD (Liquid Crystal Display), or a projector. In addition to the display device 1411, other output peripheral devices can comprise components such as speakers (not shown) and a printer (not shown) which can be connected to the computer 1401 via Input/Output Interface 1410. Any step and/or result of the methods can be output in any form to an output device. Such output can be any form of visual representation, including, but not limited to, textual, graphical, animation, audio, tactile, and the like.

The computer 1401 can operate in a networked environment using logical connections to one or more remote computing devices 1414a,b,c. By way of example, a remote computing device can be a personal computer, portable computer, a server, a router, a network computer, a peer device or other common network node, and so on. Logical connections between the computer 1401 and a remote computing device 1414a,b,c can be made via a local area network (LAN) and a general wide area network (WAN). Such network connections can be through a network adapter 1408. A network adapter 1408 can be implemented in both wired and wireless environments. Such networking environments are conventional and commonplace in offices, enterprise-wide computer networks, intranets, and the Internet 1415.

For purposes of illustration, application programs and other executable program components such as the operating system 1405 are illustrated herein as discrete blocks, although it is recognized that such programs and components reside at various times in different storage components of the computing device 1401, and are executed by the data processor(s) of the computer. An implementation of synchronization software 1406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
a. capturing information of an object;
b. generating an entry based upon the captured information; and
c. transmitting the entry to an online marketplace.

2. The method of claim 1, wherein the entry is automatically transmitted to the online marketplace.

3. The method of claim 2, further comprising automatically sharing the entry with team members on the online marketplace.

4. The method of claim 1, wherein the information comprises one or more of an image, a video, an audio recording, and a business card picture file.

5. The method of claim 4, wherein text in the business card picture file can be automatically be read and entered into the entry.

6. The method of claim 1, wherein the entry comprises one or more of a unique identifier, details, and multimedia files.

7. The method of claim 1, wherein capturing information further comprises capturing information related to a tradeshow where the object is found, wherein generating an entry further comprises generating a tradeshow entry based upon the captured information about the tradeshow and generating an item entry based upon the captured information about the object at the tradeshow, wherein the item entry is associated with the tradeshow entry.

8. The method of claim 7, wherein capturing information further comprises capturing information related to a booth where the object is found, wherein generating an entry further comprises generating a booth entry based upon captured information related to the booth, wherein the item entry is associated with the booth entry and the booth entry is associated with the tradeshow entry.

9. The method of claim 1, wherein transmitting the entry to the online marketplace comprises:
a. providing authentication credentials to the marketplace;
b. uploading the entry to the online marketplace; and
c. receiving a confirmation from the online marketplace.

10. The method of claim 1, wherein the object comprises an inspiration, wherein generating an entry comprises generating an inspiration entry based upon the captured information from the inspiration.

11. The method of claim 10, wherein the entry comprises one or more of a unique inspiration identifier, details, and multimedia files.

12. A mobile inspiration application configured for operation on a mobile wireless device, wherein the mobile inspiration application is configured to:
a. capture information of an object;
b. generate an entry based upon the captured information of the object; and
c. transmit the entry to an online marketplace.

13. The mobile inspiration application of claim 12, wherein the object further comprises an inspiration, wherein the mobile is further configured to generate an inspiration entry based upon the captured information of the inspiration, wherein the inspiration entry comprises one or more of a unique inspiration identifier, details, and multimedia files.

14. The mobile inspiration application of claim 12, wherein the object further comprises an item found at a booth of a tradeshow, wherein the mobile inspiration application is further configured to:
capture information of the item, tradeshow and the booth;
generate a tradeshow entry based upon the captured information of the tradeshow, a booth based upon the captured information of the booth, and an item entry based upon the captured information of the item; and
associate the item entry to the booth entry, associate the booth entry to tradeshow entry, and associate the item entry to the tradeshow entry.

15. The mobile inspiration application of claim 14, wherein the item further comprises a plurality of items found at the booth, the mobile inspiration application is further configured to generate a plurality of item entries and associate the plurality of item entries to the booth entry and the tradeshow entry.

16. The mobile inspiration application of claim 15, wherein the booth further comprises a plurality of booths, the mobile inspiration application is further configured to generate a plurality of booth entries and associate the plurality of booth entries to the tradeshow entry.

17. The mobile inspiration application of claim 16, wherein the tradeshow further comprises a plurality of tradeshows, the mobile inspiration application is further configured to generate a plurality of tradeshow entries.

18. The mobile inspiration application of claim 12, wherein the mobile inspiration application is configured to transmit the entry to an online marketplace by sending authentication credentials to the online marketplace, upload the entry to the online marketplace, and receive a confirmation of the upload of the entry from the online marketplace.

19. The mobile inspiration application of claim 18, wherein the mobile inspiration application is configured to automatically transmit the entry to the online marketplace.

20. A method comprising:
a. capturing information of an plurality of objects;
b. generating a plurality of entries based upon the captured information, wherein each of the plurality of entries comprises a unique identifier and one or more of details and multimedia files;
c. and generating a wish list entry from the plurality of entries.

21. The method of claim 20, further comprising automatically uploading the plurality of entries before generating a wish list entry.

22. The method of claim 20, wherein
capturing information of a plurality of objects further comprises:
capturing information of a plurality of inspirations; and
capturing information of a plurality of items found at a plurality of booths at a plurality of tradeshows; and
wherein generating a plurality of entries further comprises:
generating a plurality of inspiration entries from the captured information for each inspiration;
generating a tradeshow entry for each tradeshow;
generating a booth entry for each booth, wherein each booth entry is associated with the tradeshow entry that corresponds to the tradeshow where the booth was found; and
generating an item entry for each item, wherein each booth entry is associated with the booth entry and tradeshow entry that corresponds to the booth and tradeshow at which the item was found.

23. The method of claim 20, wherein generating a wish list entry further comprises selecting desired information from a portion of the plurality of entries and compiling the selected desired information into the wish list entry.

24. The method of claim 23, further comprising distributing the wish list entry to suppliers.

25. The method of claim 24, wherein generating a wish list entry further comprises generating a plurality of wish list entries.
